(19) United States
(12) Patent Application Publication
(10) Pub. No.: US 2011/0079659 A1
(43) Pub. Date: Apr. 7, 2011

(54) SPRAYER SYSTEM

(75) Inventors: Troy D. Wilken, Sioux City, IA (US); Rex R. Guthland, Waconia, MN (US)

(73) Assignee: Fimco Industries, North Sioux City, SD (US)

(21) Appl. No.: 12/571,956

(22) Filed: Oct. 1, 2009

(51) Int. Cl. B67D 7/08; B05B 7/26; B67D 7/56

(52) U.S. Cl. 239/73; 239/310; 239/74

(57) ABSTRACT

A sprayer system includes a pair of tanks, one for storing a dilutent and another for storing a chemical to be mixed with the dilutent in a selected concentration based on the selected orifice of a valve sprayed on the surface. Mixing of chemical with dilutent occurs on the suction side of a diaphragm pump which delivers the mixture to one or more nozzles. Should flow between either tank and the pump be interrupted, flow to the nozzles is automatically interrupted.

### FIELD OF THE INVENTION

The present invention relates to sprayer systems which mix a chemical with a dilutent for application onto a surface. More particularly, the present invention relates to sprayers used to apply chemicals including, but not limited to pesticides, herbicides, fertilizers and other agricultural chemicals.

Sprayers are used on farms, fields, golf courses and lawns to apply chemicals to crops, grasses, shrubs and other plants. Such chemicals include a variety of pesticides, herbicides, fertilizers and other materials. Such chemicals are often sold in concentrated form and must be diluted with water or some other dilutent prior to or as part of the application process. Sprayers are also used to deliver chemicals to surfaces for cleaning, coating, or the like.

Prior art sprayer systems have suffered from a number of problems. First, precision and thoroughness in mixing to achieve a consistent concentration of chemical in the mixture has been a problem. Second, a person applying the mixture has had to closely monitor the contents of the separate tanks holding the chemical concentrate and the dilutent to ensure sufficient quantities are present in the tanks. If either tank were to run dry, spraying would continue, but the spray would include either no chemical because the chemical tank ran dry or pure concentrated chemical because the dilutent tank ran dry. Third, pumps used in prior art sprayer systems were susceptible to damage due to overheating if there was an interruption of flow to the pump and the pump continued to operate. The present invention overcomes all of these deficiencies with prior art sprayer systems.

### SUMMARY OF THE INVENTION

According to the present invention, a sprayer system is provided which includes a first tank for holding a supply of a chemical concentrate and a second tank for holding a dilutent. Examples of such chemical concentrates include, but are not limited to, pesticides, herbicides and fertilizers. The sprayer system of the present invention can be used to apply other chemicals such as soaps, surfactants, lubricants, coatings and the like. The most typical example of such a dilutent is water. Dilutents other than water can be used. Likewise, the dilutent can be a mixture of water and another chemical.

Associated with the first tank is a valve regulating the flow of chemical concentrate from the first tank. The valve comprises a first plate and a second plate in face-to-face registration with the first plate. The first plate is stationary and has a first orifice. The second plate has a plurality of orifices of different sizes and is rotatable with respect to the first plate such that any of the orifices of the second plate can be selectively aligned with the orifice of the first plate to control the flow rate of chemical from the first tank through the valve.

The sprayer system of the present invention also includes a diaphragm pump having a suction port and a pressure port. A mixing connector is operatively coupled to the suction port of the pump, the first tank via the valve and the second tank such that the pump applies suction drawing chemical and dilutent into the mixing connector where the chemical and dilutent are thoroughly mixed before reaching the pump. The pump then delivers the mixture to one or more spray nozzles.

The concentration of the mixture of chemical and dilutent is determined by the selected port of the valve, i.e., which orifice of the second plate is aligned with the orifice of the first plate. In the event flow of either chemical or dilutent is interrupted because one of the tanks ran dry or for any other reason, the diaphragm pump will immediately lose prime and delivery of fluid by the pump to the nozzles will immediately cease. As such, the user need not worry about applying undiluted chemical or only dilutent. The construction of the pump is such that it will not be damaged to any significant degree if it loses prime.

The tanks of the sprayer are sufficiently translucent so the level of fluid in the tanks can be observed. The tanks are also graduated so the user can quickly ascertain the quantity of fluid in each tank. Similarly, the valve includes markings indicating its position on the concentration of the mixture.

The valve, of course, has components in addition to the two disks. For example, a pair of O-rings and a spring cooperate to provide a sealed flow path which passes through the aligned orifices of the first and second plates.

The apparatus of the present invention can be configured in a number of different ways. For example, the output of the pump can be directed through a wand to a single nozzle. Alternately, the output of the pump can be directed through a manifold or a boom to a plurality of nozzles.

The apparatus of the present invention can be packaged in a number of ways. It can be mounted to a frame so it can be worn on the back of a user, it can be mounted to a self-powered vehicle such as a truck. It can be mounted to a trailer. It can be mounted for stationary operation. As such, the power to drive the pump can be provided by an electrical motor coupled to a source of electricity, by the power takeoff of a vehicle, or in virtually any other known way to supply power to the pump depending on how the sprayer is to be used.

The invention is further described and explained below with reference to the drawings which show one example of the invention.

### BRIEF DESCRIPTION OF THE DRAWINGS

FIG. 1 is a perspective view of a sprayer system constructed in accordance with the present invention;

FIG. 2 is a left side view of the sprayer system shown in FIG. 1;

FIG. 3 is a right side view of the sprayer system shown in FIG. 1;

FIG. 4 is a front view of the sprayer system shown in FIG. 1;

FIG. 5 is a rear view of the sprayer system shown in FIG. 1;

FIG. 6 is a top view of the sprayer system shown in FIG. 1;

FIG. 7 is a bottom view of the sprayer system shown in FIG. 1;

FIG. 8 is an exploded side view showing the chemical tank and valve assembly used to meter chemical from the chemical tank of the sprayer system shown in FIG. 1;

FIG. 9 is an exploded view of the valve assembly used to meter chemical from the chemical tank of the sprayer system shown in FIG. 1;

FIG. 10 is a cross-sectional view of the valve assembly shown in FIGS. 8 and 9; and

FIG. 11 is a cross-sectional view showing a valve assembly located between the larger tank and mixing connector of the sprayer system shown in FIG. 1 to prevent backflow of chemical from the smaller tank into the larger tank.

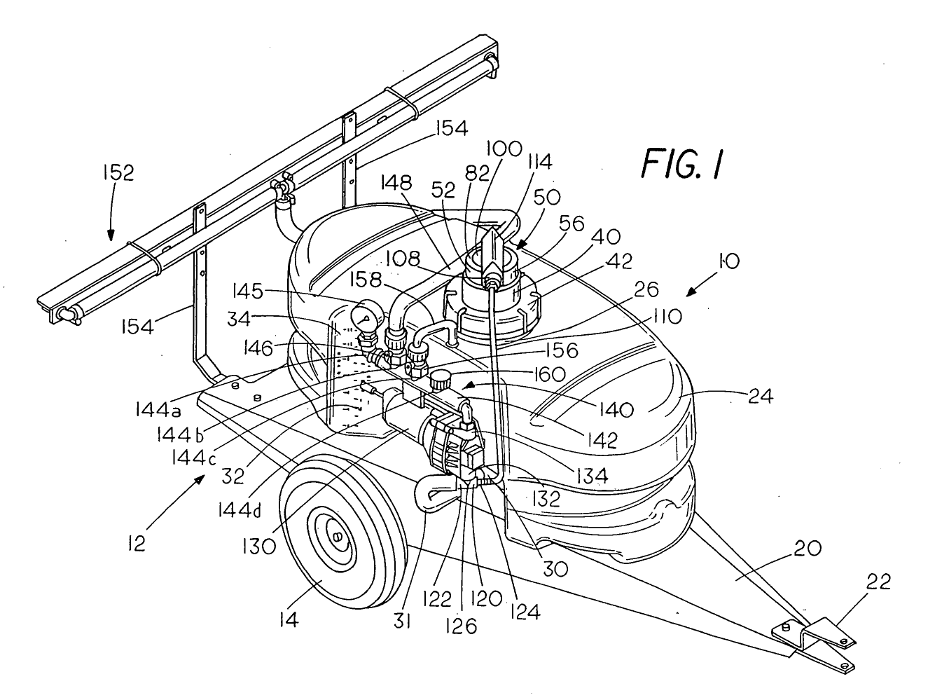

### DESCRIPTION OF THE PREFERRED EMBODIMENT

As depicted in the drawings, the sprayer system 10 is mounted on a trailer 12 supported by a pair of wheels 14 and 16 mounted to opposite ends of an axle 18. The trailer 12 has a bed 20 which supports the sprayer system 10 and a hitch 22 enabling the trailer 12 to be coupled to a tractor or other vehicle (not shown) so the trailer can be towed.

A large tank 24 is mounted to the bed of the trailer. The tank 24 can be made of any suitable plastic or metal such as polyethylene or of stainless steel. The tank 24 has a relatively large diameter threaded fill port 26 at the top and two drain ports 28 and 30 near the bottom. The drain port 28 is typically threaded and sealed by a movable cap 29 having matching threads except when the tank 24 is being drained or cleaned. A hose 31 is connected to the drain port 30. As will be explained below with reference to FIG. 11, the hose 31 can also be coupled to the drain port 30 of tank 24 via one or more valves and a pick-up tube 186. The larger tank 24 is typically used to store a dilutent such as water. The tank 24 has a series of graduated markings 32 on a translucent or transparent wall section 34 of the tank so the quantity of fluid in the tank can be easily ascertained.

A smaller tank 40 is mounted to the larger tank 24. More specifically, the smaller tank 40 is coupled to a threaded cap which is used to seal the fill port 26 of the tank 24. The smaller tank 40 sits within the fill port 26 as shown in the drawings.

The smaller tank 40 is intended to hold a chemical concentrate. Tank 40 can be made of any suitable glass, plastic or metal. The tank 40 must be sturdy and should be made of a material which is generally non-reactive with the chemical concentrate to be stored in the tank 40.

The tank 40 has a wall section 44 which is transparent or translucent and graduated so the quantity of concentrate in the tank can be easily ascertained. The tank 40 also has a threaded fill port 46 at the top. A valve assembly 50, comprising a threaded cover 52, is also shown in the drawings. The threaded cover 52 of the valve assembly 50 enables the valve assembly 50 to be removably coupled to the fill port 46 of the tank 40.

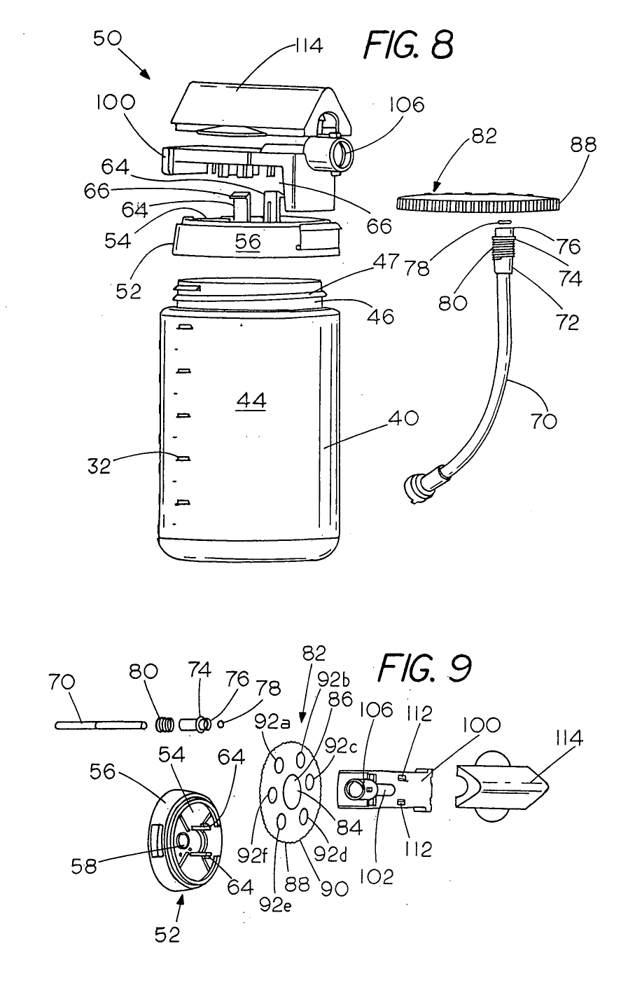

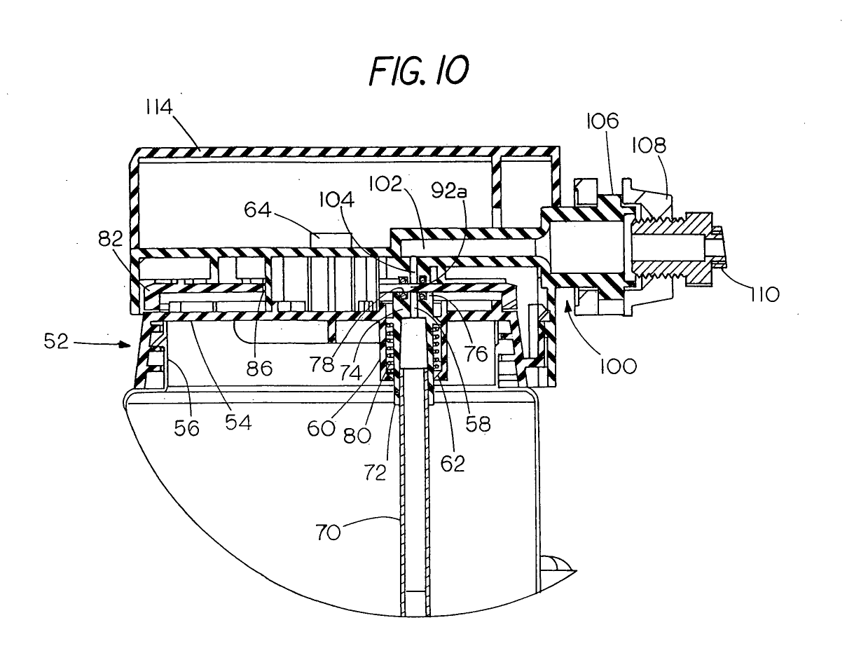

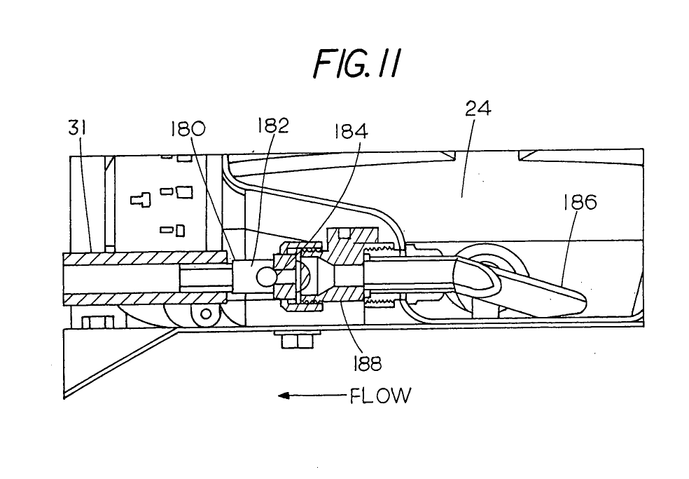

The construction of the valve assembly 50 is best shown in FIGS. 8-10. As shown, the threaded cover 52 of the valve assembly 50 has a plate 54 and a wall 56 having internal threads which cooperate with the threads 47 of the fill port 46 of the tank 40. The plate 54 has an orifice 58 extending through the plate 54. The orifice 58 is an opening surrounded by one end of a cylindrical wall 60 projecting downwardly from the plate 54 and terminating in a bottom flange 62. A pair of locking members 64 project upwardly from the plate 54. Each locking member terminates in an outwardly projecting lip 66.

The cylindrical wall 60 and flange 62 are provided to secure conduit 70 to the orifice 58. The conduit 70 extends from the orifice 58 to the bottom of the tank 40 and is provided to draw concentrate up from the bottom of the tank 40 to the orifice 58. The conduit 70 has a connector 72 which includes a flange 74 and a slot 76 for receiving an O-ring 78. When assembled, a spring 80 is passed over the conduit 70 into contact with the flange 74. The bottom of the conduit is then passed through the top of the orifice 58 so the spring 80 resides between the flange 74 of the connector 72 and the flange 62 of the cylindrical wall 60 projecting from the plate 54.

Overlying the plate 54 is a plate 82. The plate 82 has a center opening 84 defined by a wall 86 so that the plate 82 can be passed over the locking members 64. The wall 86 of the center opening 84 engages various other projections extending upwardly from the plate 54 to register and align the plates 54 and 82 with respect to each other. The registration is such that the plate 82 can easily be rotated in face-to-face registration with plate 54. The plate 82 has corrugations 88 in its outer wall 90 to assist in rotating plate 82 with respect to plate 54. Located between the walls 86 and 90 of the plate 82 are a plurality of orifices 92a-92n of different sizes. These openings 92a-92n are individually and selectably alignable with the orifice 58 in the plate 54 to control the flow of concentrate through the valve.

Overlying the plate 82 is a connector member 100. The connector member has an integrally formed conduit 102 extending from an entrance 104 positioned adjacent the point where an orifice 92a-92n of the plate 82 is aligned with the orifice 58 of the plate 54 such that the entrance 104 is in fluid communication with the conduit 70. As shown, the conduit 102 terminates at a male member 106 designed to accept a quick connect adapter 108 attached to a hose 110.

The connector member 100 also includes channel(s) 112 which permit the connector member 100 to be passed over the locking members 64 during assembly.

The valve assembly also includes a locking cap 114 overlying the connector member 100 and having slots (not shown) engaging the lips 66 of the locking members 64 to secure the components of the valve assembly 50 in place.

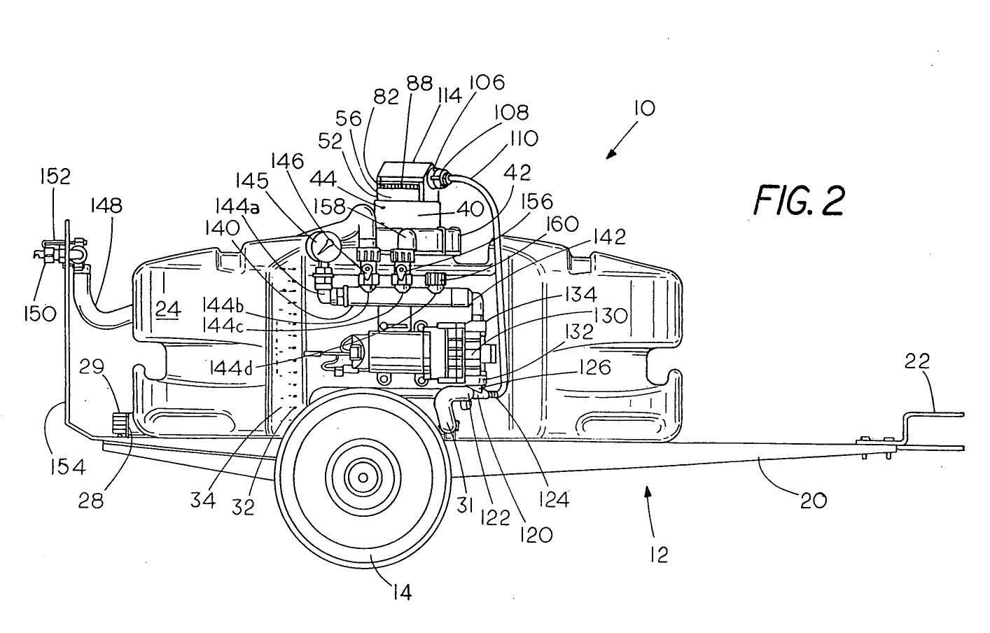

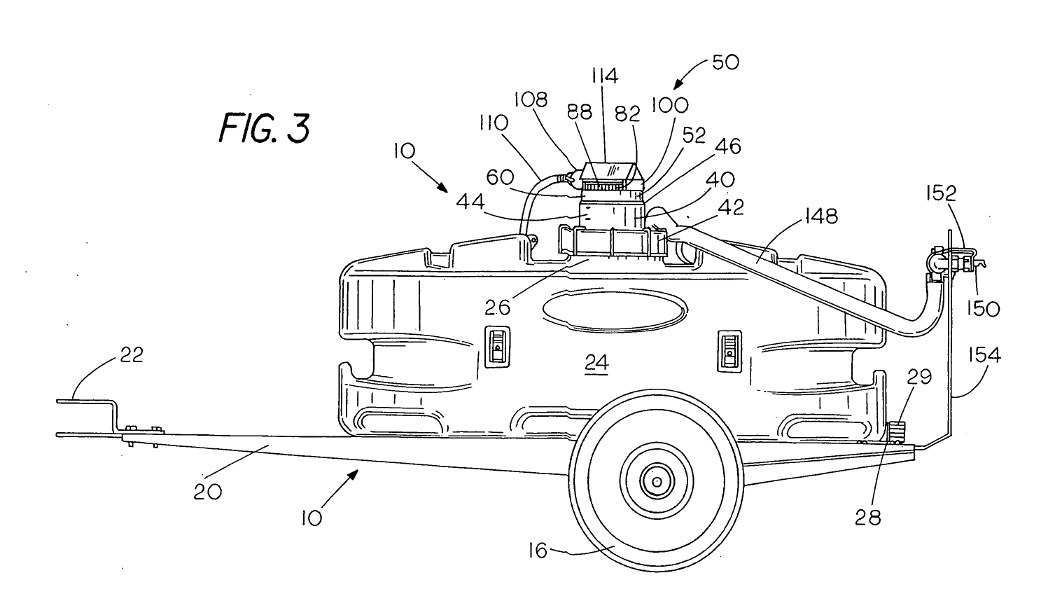

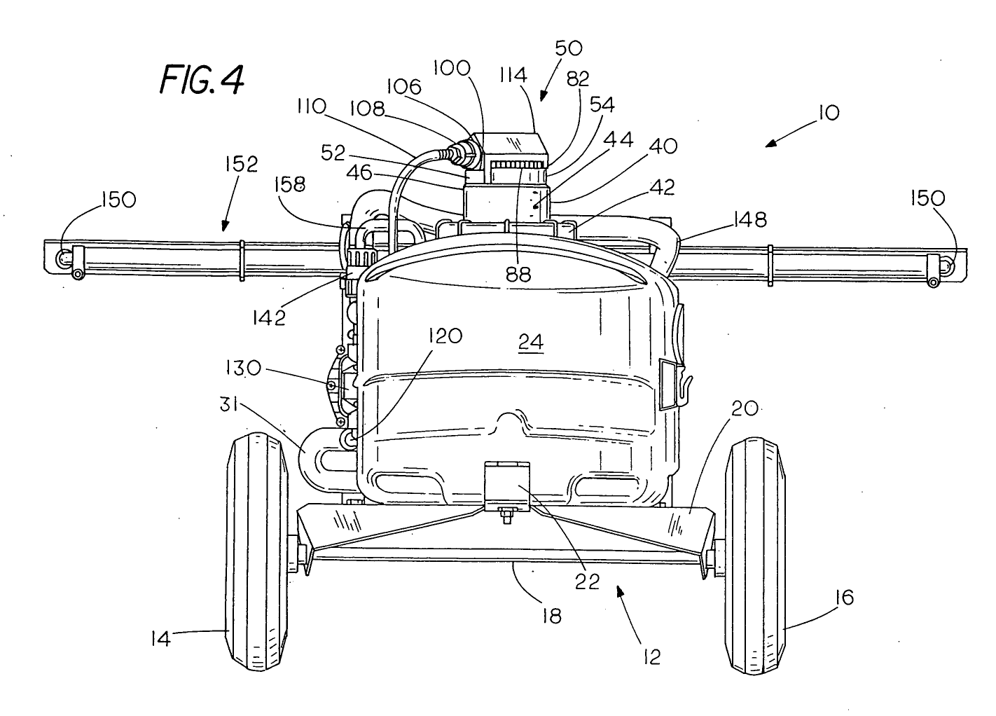

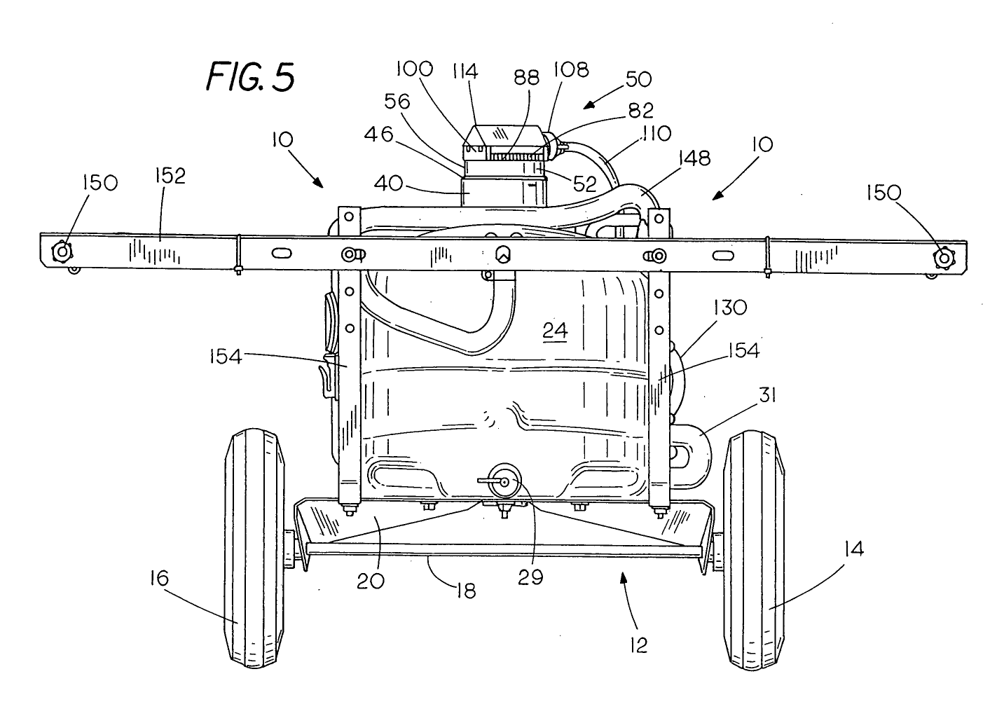

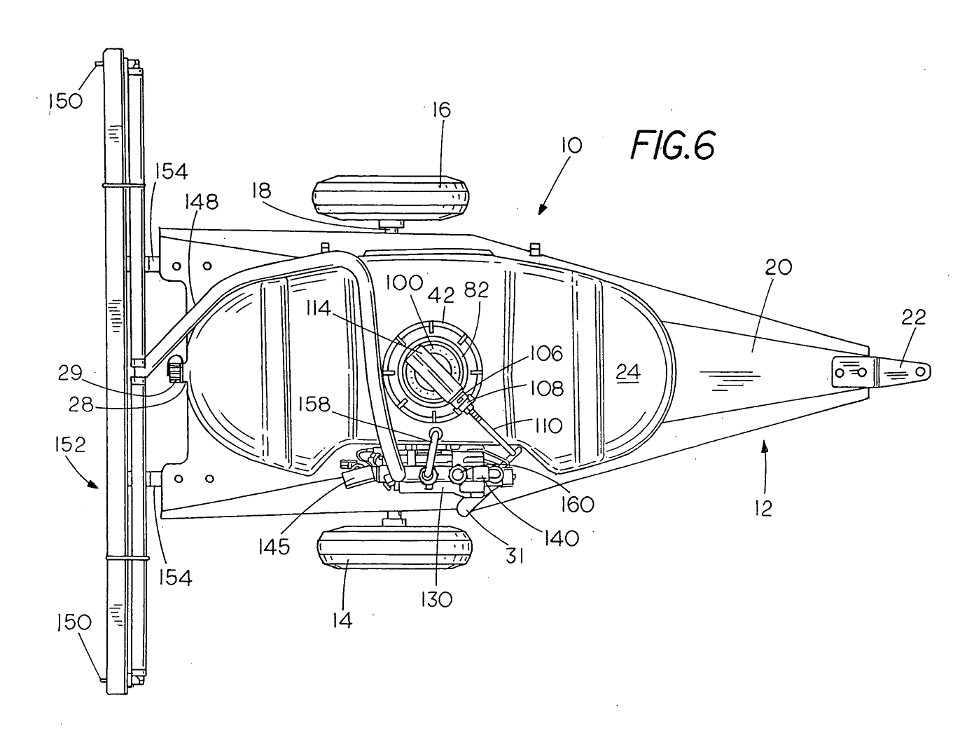

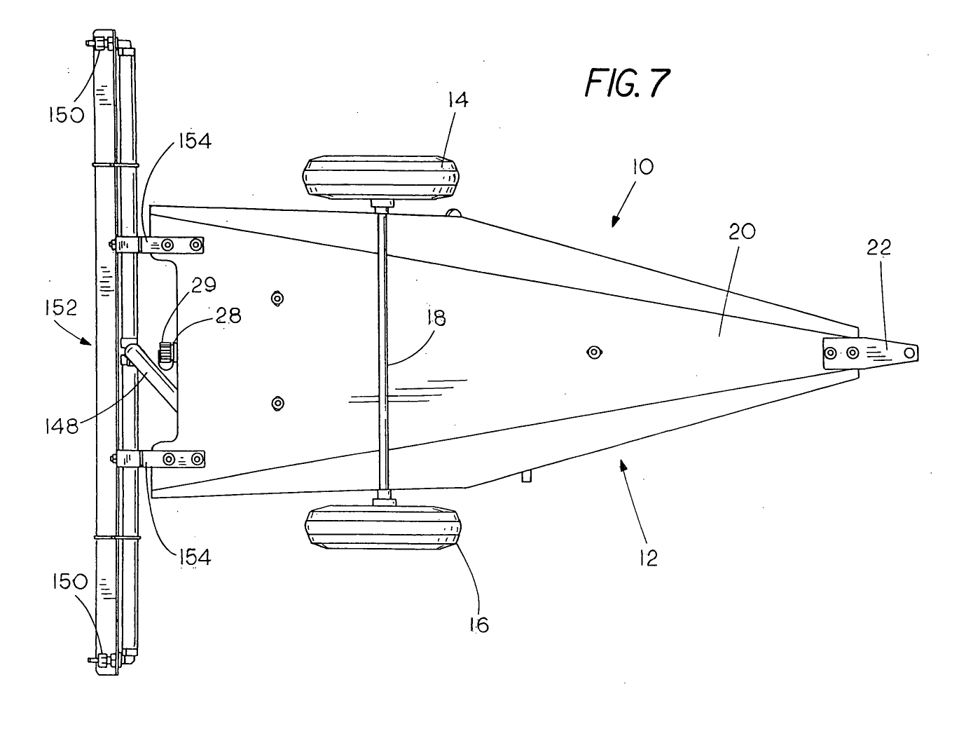

As best shown in FIG. 2, the sprayer system also includes a mixing connector 120. The mixing connector includes two input ports 122 and 124 and an output port 126. Typically, the mixing connector 120 will have a T or a Y shape. The shape used should ensure thorough mixing of the materials received at the input ports 122 and 124. As shown, the hose 31 extending from tank 24 is connected to input port 122 and the hose 110 extending from the valve assembly 50 is connected to the input port 124. The output port 126 is connected either directly or by a hose to the suction port 132 of a diaphragm pump 130.

The diaphragm pump 130 is self-lubricating such that it will not be significantly damaged if it continues to run for a reasonable period of time after losing prime. This is particularly beneficial because the pump 130 will lose prime in the event flow is interrupted from either tank 24 or tank 40. In this way, flow from the pump stops virtually immediately should either tank 24 or 40 become empty. This feature ensures only the desired mixture exits the pump and eliminates the risk that only the contents of one of the two tanks will exit the pressure port 134 of the pump 130.

As shown in FIG. 2, the pressure port 134 of the pump 130 is connected to the input 142 of manifold 140. The manifold has four outputs 144a-144d. Manifold output 144a is coupled to a pressure gauge 145. Manifold output 144b is coupled via a shutoff valve 146 to a hose 148 which, when the valve 146 is open, carries the mixture from the manifold to two nozzles 150 secured to a boom 152. The boom is attached to the trailer 12 by a pair of supports 154. The manifold output 144c is coupled by a shutoff valve 156 to a return hose 158 leading to tank 24. The manifold output 144d is sealed by a threaded cap 160. Manifold output 144d can be used to attach a separate hose (not shown) to the sprayer system. Such a hose can, in turn, be connected to a spray wand or other type of nozzle arrangement thus permitting the sprayer system of the present invention to be employed in a variety of ways.

To prevent the mixture formed in the mixing connector from flowing into the larger tank 24, a pair of valves is can be provided. These are illustrated in FIG. 11. As shown in FIG. 11, one of these valves is a check valve comprising a housing 180, a compression spring 182 and a check ball 184. The check valve is positioned between a pick-up tube 186 joined to the drain port 30 of the larger tank 24 and the hose 31 leading to the mixing connector 120. The spring 182 forces the check ball 184 against a seat of the housing 180 to hold the valve closed until sufficient suction is provided by the pump 130 to overcome the force applied by spring 182 to unseat the check ball 184. This suction force also ensures any fluid will flow away from tank 24 toward the pump 130. If the suction force ever drops below the spring force applied to the check ball 184 by the spring 182, the ball immediately resets within housing 180 to prevent backflow of liquid into the larger tank 24. Further, a shutoff valve 188 can also be provided to manually close off the tank 24 from the rest of the system.

The above description has been provided to comply with the applicable patent laws and is not intended to be limiting the scope of the invention which includes all subject matter falling within the scope of the claims set forth below and equivalents.

What is claimed is:

1. A chemical sprayer comprising:
(a) a first tank holding a chemical concentrate;
(b) a valve regulating the flow of chemical concentrate from the first tank, the valve comprises a first plate and a second plate in face-to-face registration with each other and rotatable with respect to each other to different positions, the first plate having a first orifice and the second plate having a plurality of orifices of different sizes such that any of the second orifices can be selectively aligned with the first orifice to control flow rate of chemical from the first tank through the valve;
(c) a second tank holding a dilutent;
(d) a diaphragm pump having a suction port and a pressure port;
(e) a mixing connector operatively coupled to the suction port of the pump, the first tank via the valve and the second tank such that the chemical concentrate and dilutent are mixed at a predetermined ratio before reaching the pump; and
(f) a spray nozzle operatively connected to the pressure port of the pump;
wherein flow to the nozzle stops when flow from either the first tank or the second tank to the mixing connector is interrupted.

2. The chemical sprayer of claim 1 wherein the valve further comprises an indicator identifying the position of the valve.

3. The chemical sprayer of claim 1 wherein said first tank includes a gauge identifying the volume of chemical contained in the first tank.

4. The chemical sprayer of claim 1 wherein the spray nozzle is one of a plurality of nozzles mounted to a spray boom and operatively coupled to the pressure port of the pump.

5. The chemical sprayer of claim 1 wherein the first plate of the valve is in a fixed position and said second plate of the valve rotates with respect to the first plate.

6. The chemical sprayer of claim 5 wherein said valve further comprises a first O-ring seal surrounding the first orifice and a second O-ring seal surrounding the orifice of the plurality of second orifices aligned with the first orifice.

7. The chemical sprayer of claim 6 wherein said valve includes a spring which cooperates with the first O-ring and the second O-ring to form a seal.

8. The chemical sprayer of claim 1 wherein said first tank, valve, second tank, pump and mixing connector are all carried by a trailer.

9. The chemical sprayer of claim 1 wherein the second tank includes a gauge identifying the volume of dilutent contained in the first tank.

10. The chemical sprayer of claim 1 wherein the spray nozzle is operatively connected to the pressure port of the pump via a manifold.

11. The chemical sprayer of claim 10 further comprising a pressure gauge operatively coupled to the manifold.

12. The chemical sprayer of claim 1 further comprising a valve preventing fluid from flowing from the mixing connector into the second tank.

13. The chemical sprayer of claim 12 wherein said valve is a shutoff valve.

14. The chemical sprayer of claim 12 wherein said valve is a check valve.

15. The chemical sprayer of claim 1 further comprising a check valve to prevent fluid from flowing from the mixing connector into the second tank and a shutoff valve provided to manually close off the tank 24 from the rest of the system.

16. The chemical sprayer of claim 12 wherein said check valve comprises a check ball, a spring and a housing.
